(19) United States
(12) Patent Application Publication
(10) Pub. No.: US 2017/0050395 A1
(43) Pub. Date: Feb. 23, 2017

(54) Thermoplastic Composite Material with Improved Smoke Generation, Heat Release and Mechanical Properties

(71) Applicant: Hanhwa Azdel, Inc., Forest, VA (US)

(72) Inventors: Sandra Fritz Vos, Lynchburg, VA (US); Thomas Arnold Ebeling, Forest, VA (US)

(21) Appl. No.: 15/200,068

(22) Filed: Jul. 1, 2016

Related U.S. Application Data
(63) Continuation of application No. 13/416,617, filed on Mar. 9, 2012, now abandoned.
Application No. 13/416,617 is a continuation of application No. 12/220,410, filed on Jul. 23, 2008, now abandoned.

(51) Int. Cl. B29C 70/50; B32B 27/12; B32B 27/28; B29C 65/00; B32B 37/10; B29B 7/90; B29C 65/48; B32B 5/02; B32B 37/04

(52) U.S. Cl. CPC B29C 70/504; B32B 5/022; B32B 5/024; B32B 27/12; B32B 27/281; B32B 27/285; B32B 5/028; B32B 37/04; B32B 37/10; B29B 7/90; B29C 65/48; B29C 66/712; B32B 2260/021; B32B 2260/046; B32B 2262/101; B32B 2305/076; B32B 2305/08; B32B 2305/22; B32B 2305/38; B32B 2305/026; B32B 2307/3065; B32B 2307/718; B32B 2315/085; B32B 2371/00; B32B 2379/08; B32B 2605/00; B29K 2079/085

(57) ABSTRACT

A fiber-reinforced thermoplastic composite material having an advantageous combination of smoke generation, heat release, and mechanical property characteristics. The composite generally comprises a fiber-reinforced thermoplastic core containing discontinuous reinforcing fibers bonded together with one or more thermoplastic resins. The core material may further comprise at least one first skin material applied to a first surface of the core and/or one or more second skin material applied to a second surface of the core material. The thermoplastic core material has a maximum smoke density Dₛ (4 minutes) of less than 200 as measured in accordance with ASTM E662, a maximum heat release (5 minutes) of less than 65 kW/m² as measured in accordance with FAA Heat release test FAR 25.853 (a) Appendix F, Part IV (OSU 65/65), and an average total heat release (2 minutes) of less than 65 kW/m² as measured in accordance with FAA Heat release test FAR 25.853 (a) Appendix F, Part IV (OSU 65/65). The invention is useful in the manufacture of articles for aircraft, automotive, railcar, locomotive, bus, marine, aerospace and construction in which the certain advantages may be provided over other materials utilized for such applications.

### FIELD OF THE INVENTION

This invention relates generally to fiber-reinforced thermoplastic polymer composite materials, more particularly to lightweight fiber-reinforced thermoplastic polymer composite materials that optionally include one or more skin layer materials, and to advantageous smoke generation, heat release and mechanical property characteristics of such materials and articles formed therefrom. Although not limited thereto, the invention is useful in the manufacture of aircraft, automotive, rail, bus, marine, and aerospace articles in which certain advantages may be provided over other materials utilized for such applications.

### BACKGROUND OF THE INVENTION

Driven by a growing demand by industry, governmental regulatory agencies and consumers for durable and inexpensive products that are functionally comparable or superior to metal products, a continuing need exists for improvements in composite articles subjected to difficult service conditions. This is particularly true in the automotive and other transportation industries where developers and manufacturers of articles for these applications must meet a number of competing and stringent performance specifications for such articles.

In an effort to address these demands, a number of composite materials have been developed, including glass fiber-reinforced thermoplastic composites. Such composites provide a number of advantages, e.g., they can be molded and formed into a variety of suitable products both structural and non-structural, including, among many others, automotive bumpers, interior headliners, and interior and exterior trim and structural parts. Traditional glass fiber composites used in exterior structural applications are generally compression flow molded and are substantially void free in their final part shape. By comparison, low density glass fiber composites used in automotive interior applications are generally semi-structural in nature and are porous and light weight with densities ranging from 0.1 to 1.8 g/cm³ and containing 5% to 95% voids distributed uniformly through the thickness of the finished part. The stringent requirements for certain applications, such as in the automotive, rail, marine and aircraft industries have been difficult to meet, however, for existing glass fiber composite products, particularly where such applications require a desirable combination of properties, such as light weight, good flexural and impact properties, in addition to other good characteristics, including smoke generation and heat release performance. As a result, a continuing need exists to provide further improvements in the ability of thermoplastic composite materials to meet such performance and property standards.

Various thermoplastic composite materials are well described in the art, including sheet materials comprising porous fiber-reinforced thermoplastic polymer composite sheets. In U.S. Pat. No. 7,244,501, e.g., a composite sheet material is disclosed that includes at least one porous core layer including at least one thermoplastic material having fibers contained therein, and at least one skin layer having a limiting oxygen index greater than about 22, as measured according to ISO 4589. Such composite materials are noted as providing enhanced performance characteristics of the porous fiber-reinforced thermoplastic sheet, such as flame, smoke, heat release and gaseous emissions characteristics. Notwithstanding such beneficial characteristics, there remains a need to extend the range of performance capabilities and the application areas for such materials. The present invention addresses such needs and describes certain advantageous characteristics of fiber-reinforced composite materials, particularly smoke generation, heat release, and mechanical property characteristics.

### BRIEF DESCRIPTION OF THE INVENTION

Accordingly, in one aspect of the invention, a fiber-reinforced composite is provided having an improved combination of smoke generation, heat release, and mechanical property characteristics. The composite generally comprises a fiber-reinforced thermoplastic core comprising a plurality of reinforcing fibers bonded together with one or more first thermoplastic resins in which the core has a first surface and a second surface and optionally at least one first skin applied to the first surface. The thermoplastic core material has a maximum smoke density Dₛ (4 minutes) of less than 200 as measured in accordance with ASTM E662, a maximum heat release (5 minutes) of less than 65 kW/m² as measured in accordance with FAA Heat release test FAR 25.853 (a) Appendix F, Part IV (OSU 65/65), and an average total heat release (2 minutes) of less than 65 kW/m² as measured in accordance with OSU 65/65. In general, the composite demonstrates an improved combination of flexural, tensile and smoke generation properties at reduced fiber content in the thermoplastic core. While not limited thereto, in certain aspects of the invention, the composite material may be used to form various articles such as panels, construction articles, and articles useful in automobile, marine, rail or aircraft applications.

In a particular aspect of the invention, the thermoplastic core material may be prepared by a method comprising adding reinforcing fibers and a thermoplastic resin to an agitated liquid-containing foam to form a dispersed mixture of thermoplastic resin and reinforcing fibers; depositing the dispersed mixture of reinforcing fibers and thermoplastic resin onto a forming support element; evacuating the liquid to form a web; heating the web above the softening temperature of the thermoplastic resin; and compressing the web to form the thermoplastic core material.

### BRIEF DESCRIPTION OF THE DRAWINGS

FIGS. 1-2 are sectional schematic illustrations of composite thermoplastic sheets in accordance with an embodiment of the present invention.

FIG. 3 is an enlarged schematic illustration of the composite thermoplastic sheet shown in FIG. 1.

### DETAILED DESCRIPTION OF THE INVENTION

As used in the specification and the appended claims, the singular forms “a,” “an,” and “the” include plural referents unless the context clearly dictates otherwise. Thus, for example, reference to “a thermoplastic resin” encompasses a combination or mixture of different resins as well as a single resin, reference to “a core material” or “a skin material” includes a single material or layer as well as two or more materials or layers that may or may not be the same and may be on one or more sides or surfaces of the composite material, and the like.

As used herein, the term “about” is intended to permit some variation in the precise numerical values or ranges specified. While the amount of the variation may depend on the particular parameter, as used herein, the percentage of the variation is typically no more than 5%, more particularly 3%, and still more particularly 1% of the numerical values or ranges specified.

In this specification and in the claims that follow, reference will be made to certain terms, which shall be defined to have the following meanings:

The term “basis weight” generally refers to the areal density of a fiber-reinforced thermoplastic material, typically expressed in grams per square meter (g/m² or gsm) of the material in sheet form. The term “reduced basis weight” refers to a reduction in the basis weight that may be realized for composites according to the invention relative to a comparative composite not having all of the features of the invention. As used herein, such a “comparative composite material” differs from the inventive material, e.g., in one or more of the characteristics of the fibers, thermoplastic resins, or the characteristics of the layer(s) forming part of the composite.

The term “tape” generally refers to a reinforced fibrous material in a thermoplastic resin matrix, generally including film or sheet materials. Such materials are not intended to be limited to particular dimensional or fiber orientation requirements.

The term “bi-directional” generally refers to at least two orientations, or principal directions, of unidirectional continuous fibers.

In general, the composite of the invention includes a thermoplastic core formed from one or more thermoplastic resins and discontinuous fibers dispersed within the thermoplastic resin(s). One or more skin layers may be included on one or more of the surfaces of the fiber-containing thermoplastic core. While the skin layer(s) are not required, they may be included to provide certain aesthetic and/or performance characteristics depending on the application, and as further described herein. The thermoplastic composite may be formed into various types of articles, e.g., automotive, marine and aircraft components, such as interior components and exterior body panels, as well as other articles noted herein. In certain embodiments, the composite may provide an improved combination of composite mechanical, as well as smoke generation and heat release characteristics compared to other known fiber-reinforced thermoplastic composites.

In one aspect of the invention, the smoke generation and heat release properties of the composite may be improved; e.g., the maximum smoke density Dₛ (4 minutes) may be less than 200 as measured in accordance with ASTM E662, the maximum heat release (5 minutes) may be less than 65 kW/m² as measured in accordance with FAA Heat release test FAR 25.853 (a) Appendix F, Part IV (OSU 65/65), and the average total heat release (2 minutes) may be less than 65 kW/m² as measured in accordance with FAA Heat release test FAR 25.853 (a) Appendix F, Part IV (OSU 65/65). Without limitation, the invention includes composites wherein the mechanical, smoke generation, and heat release characteristics of the composite noted herein may be improved individually or in any combination with each other. Such composites include more particular embodiments wherein, e.g., the smoke generation, and heat release properties are each within the limits noted herein, as well as any such other combination.

As described herein, the composite may be non-porous or porous. Advantageously, the thermoplastic core has a porosity greater than about 0% by volume of the thermoplastic core, particularly between about 0% to about 95% by volume of the thermoplastic core, more particularly between about 20% to about 80%, and still more particularly between about 25% to about 65% by volume of the thermoplastic core. While not required, it is also possible that the composite, which includes the thermoplastic core, is non-porous or has a porosity within the aforementioned ranges; i.e., the porosity of the composite material may generally vary between about 0% and about 95% of the total volume of the composite material, or be within the particular narrower ranges noted.

The thermoplastic resin may generally be any thermoplastic resin having a melt temperature below the resin degradation temperature, or an amorphous resin having a glass transition or softening temperature below the resin degradation temperature. Non-limiting examples of such resins include polyolefins, thermoplastic polyolefin blends, polyvinyl polymers, butadiene polymers, acrylic polymers, silicone polymers, polyamides, polyesters, polycarbonates, polyestercarbonates, polystyrenes, acrylonitrylstyrene polymers, acrylonitrile-butylacrylate-styrene polymers, polysulfones, polyarylsulfones, polyimides, polyetherimides, polyphenylene ether, polyphenylene oxide, polyphenylene-sulphide, polyethers, polyetherketones, polyethersulfones, polyacetals, polyurethanes, polybenzimidazole, and copolymers or mixtures thereof. Other thermoplastic resins can be used that can be sufficiently softened by heat to permit fusing and/or molding without being chemically or thermally decomposed during processing or formation of the composite material. Such other suitable thermoplastic resins will generally be apparent to the skilled artisan.

Fibers suitable for use in the invention include glass fibers, carbon fibers, graphite fibers, synthetic organic fibers, particularly high modulus organic fibers such as para- and meta-aramid fibers, nylon fibers, polyester fibers, or any of the thermoplastic resins mentioned above that are suitable for use as fibers, natural fibers such as hemp, sisal, jute, flax, coir, kenaf and cellulosic fibers, mineral fibers such as basalt, mineral wool (e.g., rock or slag wool), wollastonite, alumina silica, and the like, or mixtures thereof, metal fibers, metalized natural an/or synthetic fibers, ceramic fibers, or mixtures thereof. The fiber content in the thermoplastic core may be from about 20% to about 65%, more particularly from about 35% to about 50%, by weight of the thermoplastic core. Although not limited thereto, typically, the fiber content of the composite, including the core material, may vary between about 20% to about 80% by weight, more particularly between about 30% to about 70% by weight of the composite. Glass fibers useful in the invention include, e.g., E-glass, A-glass, C-glass, D glass, R-glass, S-glass, or E-glass derivatives, without limitation. Fibers suitable for use herein are further described in the patent literature (as noted herein).

While not limited thereto, the fibers dispersed within the thermoplastic resin, forming the thermoplastic core of the composite, generally have a diameter of from about 7 μm to about 22 μm, and a length of from about ⅛ in. to about 2 in.; more particularly, the fiber diameter may be from about 11 μm to about 19 μm and the fiber length may be from about ⅜ in. to about 1 in.

The composite material may further comprise additional materials or components such as additives, colorants and the like, without limitation. Such additional components may be reinforcing and/or non-reinforcing materials, as is known in the art. Although not limited thereto, suitable additives include talc and/or microspheres, such as are described in copending U.S. patent application Ser. No. 11/893,613.

The composite may generally be prepared in various forms, such as sheets or films, as layered materials on pre-formed substrates, or in other more rigid forms depending on the particular application need. For certain applications, the composite is provided in sheet form and may optionally include one or more additional layers on one or both surfaces of such a sheet. Without limitation, such surface or skin layers may be, e.g., a film, non-woven scrim, a veil, a woven fabric, a decorative scrim or film, or a combination thereof. The skin or surface layer may be desirably air permeable and may be capable of substantially stretching and spreading with the fiber-containing composite material sheet or film during thermoforming and/or molding operations. In addition, such layers may be adhesive, such as a thermoplastic material applied to the surface of the composite material. Generally, the areal density of the composite material, particularly when in sheet form, varies from about 500 g/m² to about 5000 g/m².

The composite material of the invention may be used to form various intermediate and final form articles, including construction articles or articles for use in automotive and other applications, including, without limitation, a sandwich panel, a construction article, or an automobile, marine, railcar, locomotive, or aircraft article selected from a stow bin, luggage rack, parcel shelf, package tray, headliner, door module, panel, room or space partition, skin and skirt, instrument panel topper, sidewalls, ceiling and flooring panels or tiles, cargo liner, support or pillar elements or trim materials, sunshade, trays and covers, noise and vibration shields and pads, wear pads, running boards, underbody panels, seat bases or backings, plates, shields, wheel covers and wheel wells or a facesheet or fascia material, and the like. Other such articles will be apparent to the skilled artisan. The composite material can be molded into various articles using methods known in the art, for example, pressure forming, thermal forming, thermal stamping, vacuum forming, compression forming, and autoclaving. Such methods are well known and described in the literature, e.g., see U.S. Pat. Nos. 6,923,494 and 5,601,679. Thermoforming methods and tools are also described in detail in DuBois and Pribble's “Plastics Mold Engineering Handbook”, Fifth Edition, 1995, pages 468 to 498.

It should be noted that while the inventive composite provides an improved combination of mechanical, smoke generation, and heat release characteristics, it is not necessary that all of these characteristics be individually improved. While improvement in each of these characteristics is certainly desirable, for the purposes described herein, an improved combination results if one, more than one, or all of these characteristics is or are improved relative to non-inventive or known composites.

As the thermoplastic resin containing fibers, the composite material of the invention may, according to one embodiment, include a low density glass mat thermoplastic composite (GMT) or a lightweight reinforced thermoplastic (LRT). One such product is prepared by AZDEL, Inc. and sold under the trademark SUPERLITE®. Preferably, the areal density of the such a GMT or LRT is from about 500 grams per square meter (gsm) of the GMT or LRT (g/m²) to about 5000 g/m², although the areal density may be less than 500 g/m² or greater than 5000 g/m² depending on the specific application needs. Preferably, the areal density of the thermoplastic core material is in the range of about 1000 to about 3000 gsm.

SUPERLITE® is generally prepared using chopped glass fibers, a thermoplastic resin and a thermoplastic polymer film or films and or woven or non-woven fabrics made with glass fibers or thermoplastic resin fibers such as polypropylene (PP), polybutylene terephthalate (PBT), polyethylene terephthalate (PET), polycarbonate (PC), a blend of PC/PBT, or a blend of PC/PET, polyetherimide (PEI, e.g., Ultem® resins), or with other polymers including all mentioned herein. Generally, PP, PBT, PET, PEI and PC/PET and PC/PBT blends are preferred thermoplastic resins. To produce the low density GMT or LRT, the materials and other additives are metered into a dispersing foam contained in an open top mixing tank fitted with an impeller. The foam aides in dispersing the glass fibers and thermoplastic resin binder. The dispersed mixture of glass and thermoplastic resin is pumped to a head-box located above a wire section of a paper machine via a distribution manifold. The foam, not the glass fiber or thermoplastic resin, is then removed as the dispersed mixture passes through a moving wire screen using a vacuum, continuously producing a uniform, fibrous wet web. The wet web is passed through a dryer to reduce moisture content and to melt and/or soften the thermoplastic resin. When the hot web comes out of the dryer, a thermoplastic film may be laminated into the web, e.g., by passing the web of glass fiber, thermoplastic resin and thermoplastic polymer film or films through a set of rollers. A non-woven and/or woven fabric layer may also be attached along with or in place thermoplastic film to one side or to both sides of the web to facilitate ease of handling the glass fiber-reinforced mat. The SUPERLITE® composite is then passed through tension rolls and continuously cut (guillotined) into the desired size for later forming into an end product article. Further information concerning the preparation of such composites, including suitable materials used in forming such composites that may also be utilized in the present invention, may be found in a number of U.S. patents, e.g., U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US 2005/0228108, US 2005/0217932, US 2005/0215698, US 2005/0164023, and US 2005/0161865.

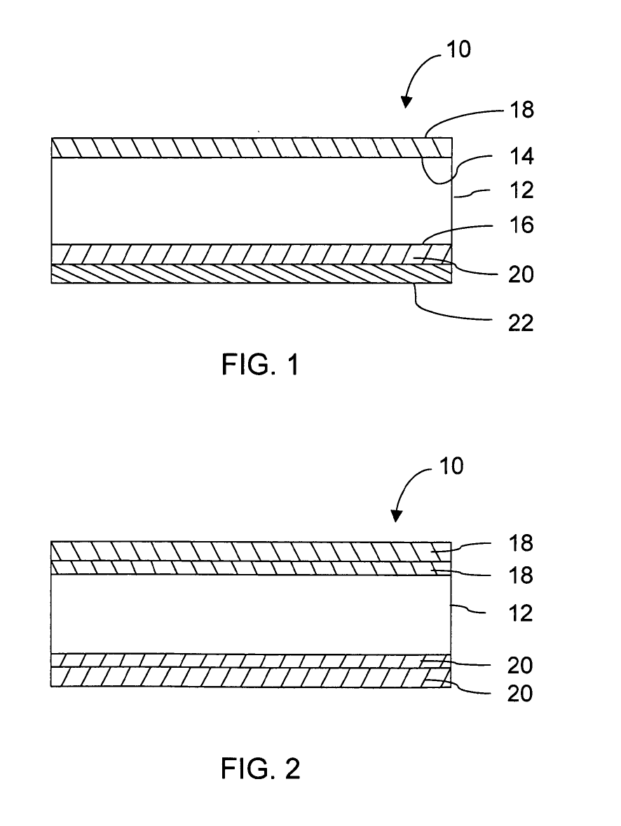

The present invention may be further understood in terms of non-limiting illustrative figures. FIGS. 1 and 2 are sectional schematic illustrations of a lightweight thermoplastic composite 10 according to the invention. In an exemplary embodiment, lightweight thermoplastic composite 10 includes a lightweight porous core 12 having a first surface 14 and a second surface 16. Optional first skin 18 may be attached to first surface 14 of core 12. An optional second skin 20 may be attached to second surface 16 of core 12. A decorative skin 22 may be bonded to second skin 20. The thermoplastic composite 10 may include decorative skins 22 bonded to first and second skins 18 and 20, or no decorative skins. Also, as described herein, the composite may include more than one first skin 18 and more than one second skin 20. The first and/or second skins may also be decorative skins bonded to the core.

Core 12 is formed from a web made up of open cell structures formed by random crossing over of fibers held together, at least in part, by one or more thermoplastic resins, where the void content of the core 12 ranges in general between greater than about 0% and about 95%, more particularly greater than about 5%, still more particularly between about 20% and about 80%, and most particularly between about 25% to about 60% of the total volume of core 12. In another aspect, porous core 12 is made up of open cell structures formed by random crossing over of reinforcing fibers held together, at least in part, by one or more thermoplastic resins, where about 40% to about 100% of the cell structure are open and allow the flow of air and gases through. Typically, core 12 has a density of about 0.1 gm/cc to about 2.25 gm/cc, more particularly about 0.1 gm/cc to about 1.8 gm/cc, and still more particularly about 0.3 gm/cc to about 1.0 gm/cc. Core 12 may be formed using known manufacturing process, for example, a wet laid process, an air or dry laid process, a dry blend process, a carding and needle process, and other processes that are employed for making non-woven products. Suitable wet laid papermaking processes for forming the core include the process described in UK Pat. Nos. 1129757 and 1329409. Combinations of such manufacturing processes may also be used.

As described herein, core 12 may include about 20% to about 65% by weight of fibers having an average length of between about ⅛ in. and about 2 in., and about 35% to about 80% by weight of a wholly or substantially unconsolidated fibrous or particulate thermoplastic materials, where the weight percentages are based on the total weight of core 12. In another aspect, core 12 includes about 35% to about 50% by weight of fibers. Fibers having an average length of between about ⅛ in. and about 1.0 in., more particularly about ⅜ in. to about 1.0 in., are typically utilized in core 12. Suitable fibers include, but are not limited to metal fibers, metalized inorganic fibers, metalized synthetic fibers, glass fibers, graphite fibers, carbon fibers, ceramic fibers, mineral fibers, basalt fibers, inorganic fibers, aramid fibers, and natural fibers, such as kenaf fibers, jute fibers, flax fibers, hemp fibers, cellulosic fibers, sisal fibers, coir fibers, and combinations thereof.

In one embodiment, fibers having an average length of about ⅛ in. to about 2 in. are added with thermoplastic powder particles such as polyetherimide (e.g., Ultem® resin), polycarbonate (e.g., Lexan® resin), polyphenylene ether, polyphenylene oxide (PPO)/polystyrene (PS) blends (e.g., Noryl® resin) powder, to an agitated aqueous foam. In another embodiment, reinforcing fibers having an average length of about ⅛ in. to about 1 in., or more particularly, about ⅜ in. to about 1 in. may be used with such resins. The components are agitated for a sufficient time to form a dispersed mixture of the reinforcing fibers and thermoplastic powder in the aqueous foam. The dispersed mixture is then laid down on any suitable support structure, for example, a wire mesh, and then the water is evacuated through the support structure forming a web. The web is dried and heated above the softening temperature of the thermoplastic powder. The web is then cooled and pressed to a predetermined thickness to produce core 12 having a porosity of greater than about 0%, more particularly between about 5% to about 95%, and still more particularly between about 20% to about 80% by volume.

The web is heated above the softening temperature of the thermoplastic resins in core 12 to substantially soften the plastic materials and is passed through one or more consolidation devices, for example calendaring rolls, double belt laminators, indexing presses, multiple daylight presses, autoclaves, and other such devices used for lamination and consolidation of sheets and fabrics so that the plastic material can flow and wet out the fibers. The gap between the consolidating elements in the consolidation devices may be set to a dimension less than that of the unconsolidated web and greater than that of the web if it were to be fully consolidated, thus allowing the web to expand and remain substantially permeable after passing through the rollers. In one embodiment, the gap is set to a dimension about 5% to about 10% greater than that of the web if it were to be fully consolidated. It may also be set to provide a fully consolidated web that is later re-lofted and molded to form particular articles or materials. A fully consolidated web means a web that is fully compressed and substantially void free. A fully consolidated web would have less than about 5% void content and have negligible open cell structure. Such fully consolidated material may be re-lofted and molded as needed to provide varying degrees of porosity.

Particulate plastic materials may include short plastics fibers that can be included to enhance the cohesion of the web structure during manufacture. Bonding is affected by utilizing the thermal characteristics of the plastic materials within the web structure. The web structure is heated sufficiently to cause the thermoplastic component to fuse at its surfaces to adjacent particles and fibers.

In one embodiment, the thermoplastic resin used to form core 12 is, at least in part, in a particulate form. Suitable thermoplastics include all of the resins noted hereinabove, without limitation.

Generally, thermoplastic resins in particulate form need not be excessively fine, although particles coarser than about 1.5 millimeters tend to not flow sufficiently during the molding process to produce a homogenous structure. The use of larger particles can also result in a reduction in the flexural modulus of the material when consolidated.

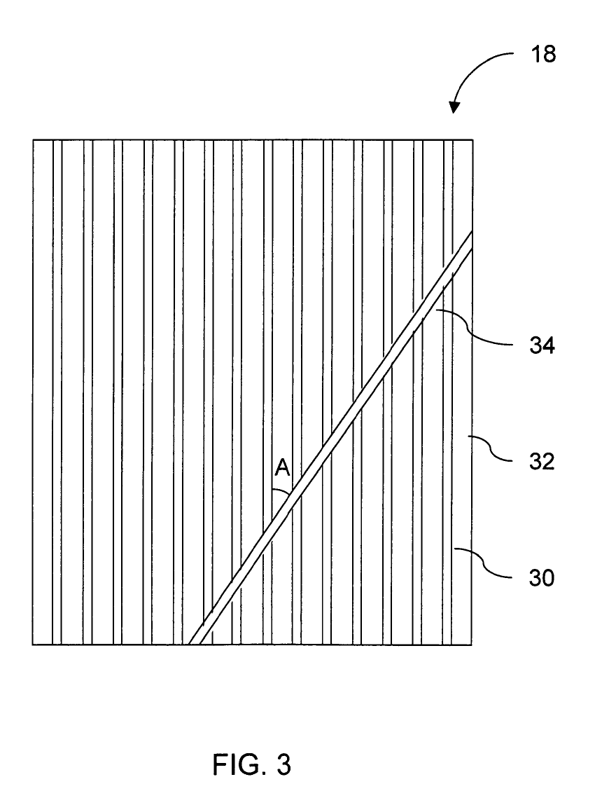

Referring to another schematic illustration according to the invention, FIG. 3 depicts a first skin 18 that includes a plurality of unidirectional fibers 30 bonded together by one or more thermoplastic resins 32. By “unidirectional” it is meant that fibers are aligned substantially parallel to each other so that the longitudinal axis of fibers 30 are substantially parallel. Skin 18 is substantially free of fiber cross-over where an angle A that a cross-over fiber 34 makes with the longitudinal axis of the aligned fibers 30 is equal to or greater than 30 degrees. (The term “substantially free” is intended to mean that greater than about 90%, more particularly greater than about 95%, of such fibers are free of fiber cross-over in the skin). For multiple first skins 18, adjacent first skins 18 include fibers that are unidirectional in each skin 18 but the aligned fibers 30 in one skin 18 may be arranged at an angle to the aligned fibers 30 in the adjacent skin 18. This angle ranges from about 0 degrees to about 90 degrees. In a further aspect of the invention, the fibers in one or more of the continuous fiber tapes of the skins may be bi-directionally oriented in a +/−45 degree orientation relative to the machine or cross direction of the skin layer. For such a construction, the relative angle between first principal direction and the second principal direction of the skin layer fibers would be about 90 degrees. Second skin 20 (as shown in FIGS. 1 and 2), similar to first skin 18, includes a plurality of unidirectional fibers 30 bonded together by one or more thermoplastic resins 32. Also, in an embodiment that includes multiple second skins 20, adjacent second skins 20 include fibers that are unidirectional in each skin 20 but the aligned fibers 30 in one skin 20 may be arranged at an angle to the aligned fibers 30 in the adjacent skin 20. When present, the second skin of the composite may include one or more second skins comprising a plurality of fibers bonded together with one or more thermoplastic resins.

The fiber-reinforced composite material of the invention includes embodiments wherein one or more tapes is utilized in which the bi-directional orientation of the continuous fibers is present in at least one of the tapes, or is achieved through the use of two or more tapes having unidirectional continuous fibers. For example, in one embodiment, the bi-directional continuous fiber tape comprises one or more first unidirectional tapes having a plurality of continuous fibers arranged in a first principal direction and one or more second unidirectional tapes having a plurality of continuous fibers arranged in a second principal direction. In this embodiment, the first and second unidirectional tapes may be independently impregnated with one or more second thermoplastic resins that are the same or different.

In another embodiment, the bi-directional continuous fiber tape comprises one or more tapes formed from a first plurality of continuous fibers arranged in a first principal direction and a second plurality of continuous fibers arranged in a second principal direction, the tape comprising both the first and second plurality of continuous fibers and being impregnated with one or more second thermoplastic resins.

In a further aspect of the invention, the bi-directional continuous fiber tape may comprise a bulk tow mat having a plurality of layers of unidirectional fiber tows, with one or more layers having unidirectional fiber tows arranged in a first principal direction and one or more layers having unidirectional fiber tows arranged in a second principal direction.

In general, the orientation of the first principal direction ranges from about 0 to about 90 degrees relative to the orientation of the second principal direction. The angle defined by a longitudinal axis of the plurality of fibers in one first skin and a longitudinal axis of the plurality of fibers in an adjacent first skin may also range between about 0 degrees to about 90 degrees.

Skins 18 and 20 may also comprise prepreg structures formed by impregnating a resin on and around aligned fibers 30. Various methods of forming prepregs may be utilized, including without limitation, solution processing, slurry processing, direct impregnation of a fiber tow with molten polymer, fiber co-mingling, sintering of thermoplastic powder into a fiber tow, and the like. Such techniques are generally known in the art and will only be briefly described herein.

More particularly, solution processing involves dissolution of the resin polymer in a solvent and impregnation of a fiber tow with the resulting low viscosity solution. Suitable solvents used include, but are not limited to, methylene chloride, acetone and N-methyl pyrrolidone. Suitable resins used include, but are not limited to, epoxies, polyimides, polysulfone, polyphenyl sulfone and polyether sulfone. Complete removal of solvent after impregnation is usually needed, and is often a difficult step.

Slurry processing provides another method of forming the prepreg structure, wherein resin polymer particles are suspended in a liquid carrier forming a slurry with the fiber tow passed through the slurry to thereby trap the particles within the fiber tow.

The prepregs can also be formed by direct impregnation of the fiber tow with molten polymer. For thermoset resins like epoxy, temperature and reaction kinetics allow for a continuous melt impregnation before reaction. For thermoplastics, two approaches can generally be used. One approach is to use a cross head extruder that feeds molten polymer into a die through which the rovings pass to impregnate the fiber tow. Another approach is to pass the fibers through a molten resin bath fitted with impregnation pins to increase the permeability of the polymer into the tow. The impregnation pins can be heated to decrease viscosity locally to further improve the impregnation process. In either case, the force exerted on the fibers, for example, die pressure for the crosshead extruder, can sometimes be high, which can cause fiber damage.

Fiber co-mingling can also be used to form the prepregs in which a thermoplastic resin is spun into a fine yarn and co-mingled with the fiber tow to produce a co-mingled hybrid yarn. These hybrid yarns may then be consolidated to form composite films.

The prepregs may also be formed by introducing dry thermoplastic powder into a fiber tow that is then processed by heating to sinter the powder particles onto the fibers. This technique includes passing the fiber tow through a bed (either fluidized or loosely packed) of thermoplastic powder, for example, polypropylene particles with an average diameter of about 250 microns. The particles stick to the fibers due to electrostatic attraction. The tow is then heated and passed through a die to produce an impregnated tow. The impregnation is macroscopic, i.e. the particles coat clusters of fibers rather than individual fibers leaving unwetted areas and voids. The process is targeted mainly at producing short fiber-reinforced thermoplastics.

Fibers described above as suitable for use in making core 12 are also suitable in skins 18 and 20. The fibers in core 12 may be the same as or different from the fibers in skins 18 and 20. The fibers in skins 18 may also be the same as or different from the fibers in skin 20.

Similarly, the thermoplastic resins described above as suitable for use in core layer 12 may also be used in skins 18 and 20. The thermoplastic resin in core 12 may be the same as or different from the thermoplastic resin in skins 18 and 20. The thermoplastic resin in skins 18 may also be the same as or different from the thermoplastic resin in skins 20.

Skins 18 and 20 may be attached to core 12 during the manufacturing process of core 12 or skins 18 and 20 can be attached prior to forming an article, for example, an automotive interior component or an automobile exterior panel. Without limitation, skins 18 and 20 can be attached to core 12 by laminating the skin(s) to core 12, sonic welding of the skin(s) to core 12, or simply laid across core 12 before the article forming process. Other suitable techniques known in the art may be used, provided the advantages of the invention are achieved.

In one exemplary embodiment, an article is formed from thermoplastic composite 10 by heating the composite to a temperature sufficient to melt the thermoplastic resin (or soften if the resin is amorphous). The heated thermoplastic composite 10 is then positioned in a mold, such as a matched aluminum mold, heated (typically in a range of about 120° C. to about 180° C.) and stamped into the desired shape using a low pressure press. Thermoplastic composite 10 can be molded into various articles using any method known in the art including, e.g., thermal forming, thermal stamping, vacuum forming, compression forming, and autoclaving.

In another embodiment, decorative layer 22 is applied to second reinforcing skin 20 by any known technique, for example, lamination, adhesive bonding, vacuum thermoforming, and the like. Decorative layer 22 may be formed, e.g., from a thermoplastic film of polyvinyl chloride, polyolefins, thermoplastic polyesters, thermoplastic elastomers, or the like. Decorative layer 22 may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. Decorative layer 22 may also be made using spunbond, thermal bonded, spunlace, melt-blown, wet-laid, and/or dry-laid processes.

While the invention has been described in terms of various specific embodiments, those skilled in the art will recognize that the invention can be practiced with modification within the spirit and scope of the claims.

All patents, patent applications, and publications mentioned herein are hereby incorporated by reference in their entireties.

### EXPERIMENTAL

The invention is further described by reference to the following examples, which are included herein for the purposes of illustration only and are not to be considered as limiting the scope of the invention as described and claimed herein.

Samples for the tests were prepared using porous composite core sheets made by the papermaking process described herein. The sheet materials contained finely dispersed filamentized chopped glass fibers with a nominal diameter of 16 microns and average chopped length of 12.7 mm (½ in.). The glass loading was nominally from 35% to 55% by weight and the porosity was approximately 35%. Polyetherimide resin (Sabic Innovative Plastics, Ultem®), polycarbonate (Sabic Innovative Plastics, Lexan®), and polyphenylene oxide/polystyrene blend resin (Sabic Innovative Plastics, Noryl®), were uniformly distributed through the thickness of the sheets used to prepare the samples. The sheets weighed nominally between 1000 grams/m² and 2000 grams/m².

The fiber-reinforced sheets were generally prepared according to the wet-laid paper making process described in UK Pat. Nos. 1129757 and 1329409. The fiber-reinforced thermoplastic sheets were further subjected to heat and pressure (e.g., in a double belt laminator or daylight press) at suitable temperatures (e.g., 380° C. and 12 bar for 2 minutes for Ultem® resin sheets) to consolidate the sheet and allow the resin to wet the fibers. The samples were then re-heated in an infra-red (IR) oven and molded in a press to a pre-determined thickness of approximately 1 mm per 1000 gsm.

Sample flame characteristics were measured using a radiant heat source and an inclined specimen of the sample material in accordance with ASTM method E-162-02A titled “Standard Method for Surface Flammability of Materials Using a Radiant Heat Energy Source”. A flame spread index was derived from the rate of progress of the flame front and the rate of heat liberation by the material under test. Key criteria are a flame spread index (FSI) and dripping/burning dripping observations. United States and Canadian requirements for passenger bus applications for interior materials are a FSI of 35 or less with no flaming drips. The Underwriters Laboratory (UL) requires that parts greater than 10 square feet should have an FSI of 200 or less to obtain a listing from UL.

The smoke characteristics were measured by exposing test specimens to flaming and non-flaming conditions within a closed chamber according to ASTM method E-662-03 titled “Standard Test Method for Specific Optical Density of Smoke Generated by Solid Materials”. Light transmissions measurements were made and used to calculate specific optical density of the smoke generated during the test time period. Key criteria are an optical density (Dₛ) of smoke produced by a sample exposed to a radiant furnace or a radiant furnace plus multiple flames. The optical density is plotted versus time for generally 20 minutes. Maximum optical density and time to reach this maximum are important outputs. United States and Canadian Rail regulations and some United States and Canadian Bus guidelines set a maximum Dₛ of 100 or less at 1.5 minutes, and a maximum Dₛ of 200 or less at 4 minutes. Global Air regulations set the Dₛ at 4 minutes for many large interior applications at 200 or less.

Toxic gas characteristics of samples were measured according to FAA requirements for toxicity and flame in accordance with FAA tests BSS-7239, developed by Boeing Corporation, and FAR 25.853 (a) Appendix F, Part IV (OSU 65/65) calorimeter.

A large part in an aircraft passenger cabin interior typically will need to meet the requirements of ASTM E662 described above as well a maximum Dₛ of 200 at 4 minutes. A difficult test for plastics has traditionally been the OSU 65/65 heat release test. In this test, the test material is exposed to defined radiant heat source, and calorimeter measurements are recorded. Key criteria are an average maximum heat release during the 5 minute test that should not exceed 65 kW/m², and an average total heat released during the first 2 minutes of the test that should not exceed 65 kW-min/m².

In the 60 second vertical burn test, the part is exposed to a small-scale open flame for 60 seconds and the key criteria are a burned length of 150 mm or less, an after flame time of 15 seconds or less, and flame time drippings of 3 seconds or less.

Mechanical properties (flexural and tensile properties) for porous fiber-reinforced sheet materials according to the invention were measured according to ISO 178 and 527.

### Smoke Generation Characteristics

Smoke characteristics for porous fiber-reinforced sheet materials according to the invention formed from polyetherimide (Ultem®), as noted above, and measured according to ASTM E662, are shown in Table 1.

TABLE 1
Smoke Generation Characteristics¹ for Polyetherimide
(Ultem ®) Core Composite Material

| | Core Properties | | Smoke |
|---|---|---|---|
| | Basis | Glass | Density¹ |
| Sample | Weight | Content | Dₛ |
| ID | (gsm) | (%) | (4 min.) |
| 1 | 1500 | 40 | 11 |
| 2 | 1000 | 35 | 14 |
| 3 | 1000 | 45 | 5 |
| 4 | 1000 | 55 | 6 |
| 5 | 1500 | 35 | 11 |
| 6 | 1500 | 45 | 10 |
| 7 | 1500 | 55 | 4 |
| 8 | 2000 | 35 | 7 |
| 9 | 2000 | 45 | 9 |
| 10 | 2000 | 55 | 4 |

¹non-flaming smoke density, ASTM E662

From Table 1, it may be noted that the smoke density results obtained are lower than results disclosed in U.S. Pat. No. 7,244,501, thereby demonstrating the novel and non-obvious benefits of the present invention.

Smoke characteristics for porous fiber-reinforced sheet materials according to the invention formed from polycarbonate (Lexan®), as noted above, and measured according to ASTM E662, are shown in Table 2.

TABLE 2
Smoke Generation Characteristics¹ for Polycarbonate
(Lexan ®) Core Composite Material

| | Core Properties | | | Smoke |
|---|---|---|---|---|
| | Basis | Glass | Bromine | Density¹ |
| Sample | Weight | Content | Content | Dₛ |
| ID | (gsm) | (%) | (%) | (4 min.) |
| 1 | 1000 | 35.0 | 2.0 | 123 |
| 2 | 1000 | 55.0 | 2.0 | 118 |
| 3 | 2000 | 35.0 | 2.0 | 90 |
| 4 | 2000 | 55.0 | 2.0 | 86 |
| 5 | 1500 | 45.0 | 2.0 | 81 |
| 6 | 1500 | 35.0 | 7.5 | 95 |
| 7 | 1500 | 40.0 | 7.5 | 98 |
| 8 | 1500 | 45.0 | 7.5 | 95 |
| 9 | 1500 | 55.0 | 7.5 | 107 |
| 10 | 1000 | 35.0 | 13.0 | 76 |
| 11 | 1000 | 55.0 | 13.0 | 66 |
| 12 | 2000 | 35.0 | 13.0 | 97 |
| 13 | 2000 | 55.0 | 13.0 | 95 |
| 14 | 1500 | 45.0 | 13.0 | 129 |

¹non-flaming smoke density ASTM E662

From Table 2, it may be noted that the smoke density results obtained meet the standards associated with ASTM E662, thereby further demonstrating the beneficial characteristics of the present invention.

### Marine Smoke Density and Toxic Gas Characteristics

Marine smoke density characteristics for porous fiber-reinforced sheet materials according to the invention formed from polyetherimide (Ultem® 1040), polycarbonate (Lexan® FST) and polyphenylene oxide/polystyrene blend (Noryl®) resins, as noted above, are shown in Table 3. From Table 3, it is apparent that the gaseous smoke components are in many cases significantly lower than the test standard requirement.

TABLE 3
Marine Smoke Density and Toxic Gas¹ Characteristics for Thermoplastic Core Composite Materials²

| Smoke Component | | Ultem ® 1040 | | | Lexan ® FST | | | Noryl ® | | |
|---|---|---|---|---|---|---|---|---|---|---|
| | Required | 25 kW/m² | 25 | 50 | 25 kW/m² | 25 | 50 | 25 kW/m² | 25 | 50 |
| | Maximum¹ | with | kW/m² | kW/m² | with | kW/m² | kW/m² | with | kW/m² | kW/m² |
| Component | (ppm) | flame | no flame | no flame | flame | no flame | no flame | flame | no flame | no flame |
| Ds | note 3 | 10 | 29 | 115 | 29 | 205 | 293 | 121 | 245 | 437 |
| CO | 1450 | 100 | 500 | 200 | 300 | 100 | 500 | 100 | 100 | 1000 |
| HF | 600 | <0.5 | <0.5 | <0.5 | <0.5 | <0.5 | <0.5 | 2 | <0.5 | <0.5 |
| HCl | 600 | <1.0 | <1.0 | <1.0 | <1.0 | <1.0 | <1.0 | <1.0 | <1.0 | <1.0 |
| HCN | 140 | 2 | 30 | 5 | <2.0 | 10 | 10 | <2.0 | 5 | 2 |
| SO₂ | 120 | <1.0 | <1.0 | <1.0 | <1.0 | <1.0 | <1.0 | <1.0 | <1.0 | <1.0 |
| NO, NO₂ | 350 | 5 | <2.0 | <2.0 | <2.0 | <2.0 | <2.0 | 10 | <2.0 | <2.0 |
| HBr | 600 | <1.0 | <1.0 | <1.0 | <1.0 | <1.0 | <1.0 | <1.0 | <1.0 | <1.0 |

¹BSS 7239; IMO Resolution MSC 61 (67): Annex 1, Part 2, Smoke and Toxicity;
²no scrims, 1500 gsm handsheets with 40% glass;
³Dm <200 for materials used as surface bulkheads, linings, or ceilings; Dm <400 for materials used as primary deck covering, as plastic pipes, or electric cable coverings; Dm <500 for materials used as floor covering.

### Flexural and Tensile Property Characteristics

Flexural and tensile properties for porous fiber-reinforced sheet materials according to the invention formed from polyetherimide (Ultem®) core materials, as noted above, and measured according to ISO 178 and 527, are shown in Table 4. Results for polycarbonate (Lexan®), as noted above, are shown in Table 5. All samples in Tables 4 and 5 had void contents of 55% (±5%).

TABLE 4
Mechanical Property Characteristics for Polyetherimide
(Ultem ®) Core Composite Material

| | | | Smoke | MD | MD |
|---|---|---|---|---|---|
| | Glass | Basis | Density¹ | Flexural | Tensile |
| Sample | Content | Weight | Dₛ | Modulus² | Modulus² |
| ID | (%) | (g/m²) | (4 min.) | (MPa) | (MPa) |
| 1 | 35.0 | 1000 | 11 | 2717 | 4989 |
| 2 | 35.0 | 1000 | 15 | 2492 | 4848 |
| 3 | 35.0 | 1000 | 15 | 3139 | 4397 |
| 4 | 35.0 | 1000 | — | 2358 | 5654 |
| 5 | 35.0 | 1000 | — | 2588 | 4907 |
| 6 | 45.0 | 1000 | 3 | 2910 | 2711 |
| 7 | 45.0 | 1000 | 7 | 2604 | 5771 |
| 8 | 45.0 | 1000 | 4 | 2484 | 2694 |
| 9 | 45.0 | 1000 | — | 4136 | 2542 |
| 10 | 45.0 | 1000 | — | 3752 | 4336 |
| 11 | 55.0 | 1000 | 9 | 1847 | 2458 |
| 12 | 55.0 | 1000 | 4 | 930 | 2128 |
| 13 | 55.0 | 1000 | 6 | 913 | 2432 |
| 14 | 55.0 | 1000 | — | 473 | 2602 |
| 15 | 55.0 | 1000 | — | 1117 | 2469 |
| 16 | 35.0 | 1500 | 10 | 1807 | 3460 |
| 17 | 35.0 | 1500 | 8 | 2181 | 3332 |
| 18 | 35.0 | 1500 | 14 | 3056 | 3334 |
| 19 | 35.0 | 1500 | — | 2267 | 3144 |
| 20 | 35.0 | 1500 | — | 1791 | 3752 |
| 21 | 40.0 | 1500 | 8 | 3933 | 4548 |
| 22 | 40.0 | 1500 | 11 | 2951 | 3958 |
| 23 | 40.0 | 1500 | 13 | 3737 | 2789 |
| 24 | 40.0 | 1500 | — | 3190 | 4506 |
| 25 | 40.0 | 1500 | — | 3575 | 3836 |
| 26 | 45.0 | 1500 | 9 | 2074 | 2989 |
| 27 | 45.0 | 1500 | 9 | 2482 | 3548 |
| 28 | 45.0 | 1500 | 12 | 1872 | 3253 |
| 29 | 45.0 | 1500 | — | 2979 | 3673 |
| 30 | 45.0 | 1500 | — | 2976 | 3791 |
| 31 | 55.0 | 1500 | 7 | 678 | 1058 |
| 32 | 55.0 | 1500 | 2 | 419 | 1202 |
| 33 | 55.0 | 1500 | 4 | 703 | 1478 |
| 34 | 55.0 | 1500 | — | 646 | 2136 |
| 35 | 55.0 | 1500 | — | 1010 | 1405 |
| 36 | 35.0 | 2000 | 6 | 1435 | 3580 |
| 37 | 35.0 | 2000 | 5 | 1327 | 4283 |
| 38 | 35.0 | 2000 | 10 | 1353 | 4541 |
| 39 | 35.0 | 2000 | — | 1855 | 3648 |
| 40 | 35.0 | 2000 | — | 1155 | 4563 |
| 41 | 45.0 | 2000 | 10 | 1043 | 3453 |
| 42 | 45.0 | 2000 | 8 | 840 | 3503 |
| 43 | 45.0 | 2000 | 10 | 872 | 4681 |
| 44 | 45.0 | 2000 | — | 1074 | 4422 |
| 45 | 45.0 | 2000 | — | 776 | 4340 |
| 46 | 55.0 | 2000 | 4 | 1046 | 2502 |
| 47 | 55.0 | 2000 | 6 | 904 | 4344 |
| 48 | 55.0 | 2000 | 3 | 1122 | 4065 |
| 49 | 55.0 | 2000 | — | 751 | 3719 |
| 50 | 55.0 | 2000 | — | 1026 | 6260 |

¹flaming smoke density, ASTM E662;
²MD = machine direction, handsheets

TABLE 5
Mechanical Property Characteristics for Polycarbonate
(Lexan ®) Core Composite Material

| | | | | Smoke | | |
|---|---|---|---|---|---|---|
| | Glass | Basis | Bromine | Density¹ | Flexural | Tensile |
| Sample | Content | Weight | content | Dₛ | Modulus² | Modulus² |
| ID | (%) | (g/m²) | (%) | (4 min.) | (MPa) | (MPa) |
| 1 | 35.0 | 1000 | 2.0 | 123 | 1459 | 2214 |
| 2 | 55.0 | 1000 | 2.0 | 118 | 1527 | 3323 |
| 5 | 45.0 | 1500 | 2.0 | 81 | 1853 | 3571 |
| 3 | 35.0 | 2000 | 2.0 | 90 | 2628 | 2804 |
| 4 | 55.0 | 2000 | 2.0 | 86 | 1945 | 4175 |
| 6 | 35.0 | 1500 | 7.5 | 95 | 1880 | 3130 |
| 7 | 40.0 | 1500 | 7.5 | 98 | 1694 | 5177 |
| 8 | 45.0 | 1500 | 7.5 | 95 | 1820 | 4120 |
| 9 | 55.0 | 1500 | 7.5 | 107 | 2205 | 3523 |
| 10 | 35.0 | 1000 | 13.0 | 76 | 1650 | 2841 |
| 11 | 55.0 | 1000 | 13.0 | 66 | 1062 | 3662 |
| 14 | 45.0 | 1500 | 13.0 | 129 | 1173 | 3025 |
| 12 | 35.0 | 2000 | 13.0 | 97 | 1401 | 3906 |
| 13 | 55.0 | 2000 | 13.0 | 95 | 1776 | 3098 |

¹non-flaming smoke density, ASTM E662;
²geometric means of MD and CD, handsheets

From Table 4 and 5, it may be noted that the smoke density values are relatively unchanged with increasing resin content (decreasing ash content or increasing basis weight). In addition, although mechanical properties typically increase with increasing amount of reinforcement in plastic composite materials, the above data suggest flex performance characteristics that are greater in a middle glass content range and an increase in tensile properties as the glass fiber loading is decreased.

The above results demonstrate that core materials according to the invention demonstrate advantageous smoke density, heat release and mechanical properties relative to the testing standards applicable for materials used in marine, aviation, and other applications. In addition, superior results may be noted in smoke density and heat release characteristics for the core materials of the invention compared to the results shown for the materials described in U.S. Pat. No. 7,244,501.

1-26. (canceled)

27. A method of producing a thermoplastic core comprising:
adding a plurality of discontinuous reinforcing fibers and a thermoplastic resin to an agitated liquid-containing foam to form a dispersed mixture of thermoplastic resin and reinforcing fibers;
depositing the dispersed mixture of reinforcing fibers and thermoplastic resin onto a forming support element;
evacuating the liquid from the deposited, dispersed mixture to form a web;
heating the web above a softening temperature of the thermoplastic resin; and
compressing the web to form a thermoplastic core comprising a maximum smoke density Ds (4 minutes) of less than 200 as measured in accordance with ASTM E662, a maximum heat release (5 minutes) of less than 65 kW/m² as measured in accordance with FAA heat release test FAR 25.853 (a) Appendix F, Part IV (OSU 65/65), and an average total heat release (2 minutes) of less than 65 kW/m² as measured in accordance with FAA Heat release test FAR 25.853 (a) Appendix F, Part IV (OSU 65/65).

28. The method of claim 27, wherein the thermoplastic core material comprises a porosity between about 25% to about 65% by volume of the thermoplastic core material.

29. The method of claim 28, wherein the reinforcing fibers and the thermoplastic resin are metered into a dispersing foam contained in an open top mixing tank fitted with an impeller to form the dispersed mixture.

30. The method of claim 29, further comprising pumping the dispersed mixture to a head-box located above the forming support element.

31. The method of claim 30, further comprising passing the web through a dryer to heat the web.

32. The method of claim 31, further comprising laminating a skin layer to the web prior to compression of the web.

33. The method of claim 32, further comprising passing the web with the laminated skin layer through a set of rollers to compress the web and form the thermoplastic core.

34. The method of claim 32, further comprising attaching a non-woven layer or woven fabric layer to one side of the thermoplastic core.

35. The method of claim 32, further comprising configuring the thermoplastic resin to comprise polyetherimide and configuring the reinforcing fibers to comprise glass fibers.

36. The method of claim 32, further comprising adding a flame retardant to the dispersed mixture prior to evacuating the liquid.

37. The method of claim 32, wherein no skin layer having a limiting oxygen index greater than about 22, as measured according to ISO 4589, is laminated to the thermoplastic core.

38. The method of claim 32, wherein the average heat release of the thermoplastic core is less than about 45 kW/m².

39. The method of claim 38, wherein the areal density of the thermoplastic core is between about 1000 gsm to about 3000 gsm, wherein the reinforcing fibers are present in the thermoplastic core at about 20 weight percent to about 65 weight percent, and wherein the reinforcing fibers have a nominal length of about ⅜ inch to about 1 inch and a nominal diameter of about 11 microns to about 19 microns.

40. The method of claim 37, wherein the areal density of the thermoplastic core is between about 1000 gsm to about 3000 gsm, and the skin layer is a glass fabric.

41. The method of claim 37, wherein the areal density of the thermoplastic core is between about 1000 gsm to about 3000 gsm, and the skin layer is a glass fabric impregnated with resin or polymer.

42. The method of claim 37, wherein the areal density of the thermoplastic core is between about 1000 gsm to about 3000 gsm, and the skin layer is a glass/polymer woven fabric.

43. The method of claim 37, wherein the areal density of the thermoplastic core is between about 1000 gsm to about 3000 gsm, and the skin layer is a non-woven scrim.

44. The method of claim 37, wherein the areal density of the thermoplastic core is between about 1000 gsm to about 3000 gsm, and the skin layer is a decorative film.

45. The method of claim 37, wherein the thermoplastic resin is a polyolefin, the reinforcing fibers are glass fibers present in the thermoplastic core at about 20 weight percent to about 65 weight percent, and wherein the glass reinforcing fibers have a nominal length of about ⅜ inch to about 1 inch and a nominal diameter of about 11 microns to about 19 microns, the areal density of the thermoplastic core is between about 1000 gsm to about 3000 gsm, the skin layer on the thermoplastic core is a glass fabric or a glass fabric impregnated with resin or polymer.

46. The method of claim 37, wherein the thermoplastic resin is a polyolefin, the reinforcing fibers are glass fibers present in the thermoplastic core at about 20 weight percent to about 65 weight percent, and wherein the glass reinforcing fibers have a nominal length of about ⅜ inch to about 1 inch and a nominal diameter of about 11 microns to about 19 microns, the areal density of the thermoplastic core is between about 1000 gsm to about 3000 gsm, the skin layer on the thermoplastic core is a non-woven scrim.

47. The method of claim 37, wherein the thermoplastic resin is a polyolefin, the reinforcing fibers are glass fibers present in the thermoplastic core at about 20 weight percent to about 65 weight percent, and wherein the glass reinforcing fibers have a nominal length of about ⅜ inch to about 1 inch and a nominal diameter of about 11 microns to about 19 microns, the areal density of the thermoplastic core is between about 1000 gsm to about 3000 gsm, the skin layer on the thermoplastic core is a glass/polymer woven fabric.
